(19) United States
(12) Patent Application Publication
(10) Pub. No.: US 2005/0049101 A1
(43) Pub. Date: Mar. 3, 2005

(54) Self lubricating gear shaft for differential assembly

(76) Inventors: Rajendra G. Kumashi, Clarkston, MI (US); Yian Liu, Novi, MI (US); Vincent D. Monkaba, Shelby Township, MI (US)

Correspondence Address: Craig A. Phillips;Dickinson Wright PLLC, Suite 800, 1901 L Street N.W., Washington, DC, 20036, US

(21) Appl. No.: 10/649,914

(22) Filed: Aug. 26, 2003

(51) Int. Cl. F16H 57/04

(52) U.S. Cl. 475/160

(57) ABSTRACT

A gear shaft having a tubular body defining an axially extending cavity and an outer surface having a first engagement area for rotatably supporting a gear, and wherein a passage extends between the cavity and the engagement area for providing lubrication between the first engagement area of the gear shaft and the gear to reduce friction.

### BACKGROUND OF THE INVENTION

The present invention relates to gear shafts for supporting a gear for rotation thereon, and more particularly to self lubricating differential assemblies.

Gear shafts configured to support a gear for rotation thereon are well known in the art. An example of such a gear shaft is a pinion shaft in a differential assembly. Conventional differential assemblies generally include a differential case which encases a pair of side gears and pinion gears. A pinion shaft is coupled to the differential case for rotation therewith, and the pinion gears are rotatably disposed on the pinion shaft. As a differential case is rotated, torque is transferred to the side gears. During turning or other vehicle maneuvers, the side gears rotate at different speeds. To allow the side gears to rotate at different speeds, the pinion gears rotate upon the pinion shaft, allowing the engaged side gears to rotate relative to one another.

Pinion shafts about which the pinion gears rotate are commonly cylindrical, solid shafts that are coupled to rotate with the differential case. To reduce wear and unwanted frictional engagement, it is desirable to ensure lubrication between the pinion gear and the pinion shaft.

As manufacturers strive to improve fuel economy and other benefits associated with lightweight vehicles, it is also desirable to reduce the weight of every component in a vehicle, without reducing the reliability or strength of the part. Therefore, it is advantageous to reduce the weight of the differential pin. Some differential pins have been known to include flattened portions or “H” or “I” shapes to improve lubrication and reduce weight. Problems with these differentials may include longevity of the differential pin, difficulty in providing the needed lubricant between the pinion gear and pinion shaft, and increased manufacturing costs.

### SUMMARY OF THE INVENTION

In view of the above, the present invention is directed to a gear shaft having a tubular body defining an axially extending cavity and an outer surface having a first gear engagement area for rotatably supporting a gear. A passage extends from the cavity to the gear engagement area to provide lubrication between the gear and the gear shaft. The tubular body includes at least one open end communicating with the cavity. The outer surface may further include a recessed pocket in the gear engagement area wherein the passage extends between the cavity and the recessed pocket to provide lubrication fluid to the recessed pocket. Lubrication fluid from the passage or recessed pocket may be drawn around the gear shaft to provide reduce friction between the gear and gear shaft.

The present invention is further directed to a differential assembly having a differential case rotatable about an axis and a gear assembly partially submerged in lubrication fluid, wherein the gear assembly includes a pinion shaft secured to the differential case for rotation therewith. The pinion shaft includes a first and second open end configured to be submerged in the lubrication fluid as the differential case rotates. The pinion shaft further includes an elongated cavity extending between the first and second ends, an outer surface, and a passage extending between the elongated cavity and the outer surface. The elongated cavity receives lubrication fluid as the ends are submerged during rotation wherein the received lubrication fluid passes from the elongated cavity outwardly through the passage. The gear assembly further includes a pinion gear rotatably supported by the pinion shaft, wherein the lubrication fluid passes from the elongated cavity to form a lubrication barrier between the gear engagement area and the pinions.

The present invention is yet further directed to a differential assembly having a differential case, a pinion shaft secured to the differential case for rotation therewith and a set of spaced apart pinion gears rotatably supported by the pinion shaft. The pinion shaft defines an elongated cavity, an outer surface, and a passage extending from the elongated cavity to the outer surface. The outer surface may include a gear engagement area wherein the passage extends outwardly from the elongated cavity to the gear engagement area.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a section view of a differential assembly according to the present invention showing a differential case partially submerged in lubrication fluid contained within a housing;

FIG. 2 is a section of the differential case and assembly;

FIG. 3 is a section along line 3-3 in FIG. 1;

FIG. 4 is a perspective view of the differential pin;

FIG. 5 is a section view of an alternative embodiment of the differential pin.

### DETAILED DESCRIPTION OF THE PREFERRED EMBODIMENT

The present invention relates to a gear shaft 30 for rotatably supporting a gear 14. In the illustrated embodiment below, the gear shaft 30 is described herein for use in a differential assembly as a pinion shaft and the rotatable gears are described as pinion gears. One skilled in the art should readily recognize that, with minor modifications, the illustrated pinion shaft may be used in a variety of other torque transfer devices for rotatably supporting a gear, such as a transmission, a transaxle, and a power take-off unit.

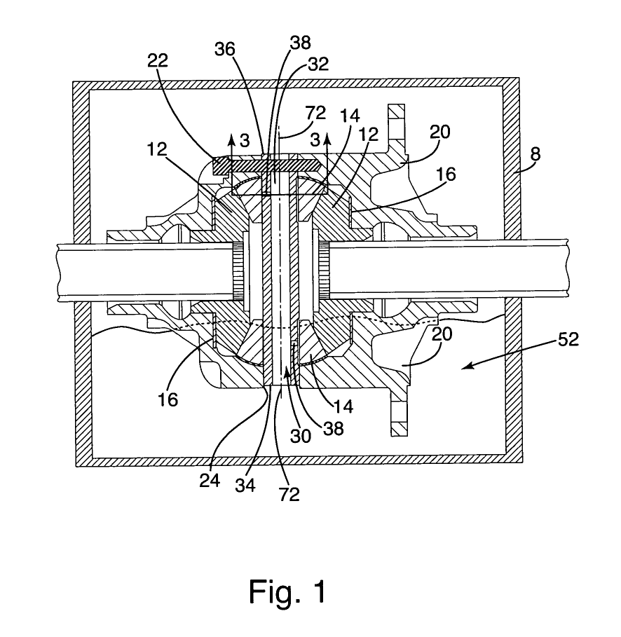

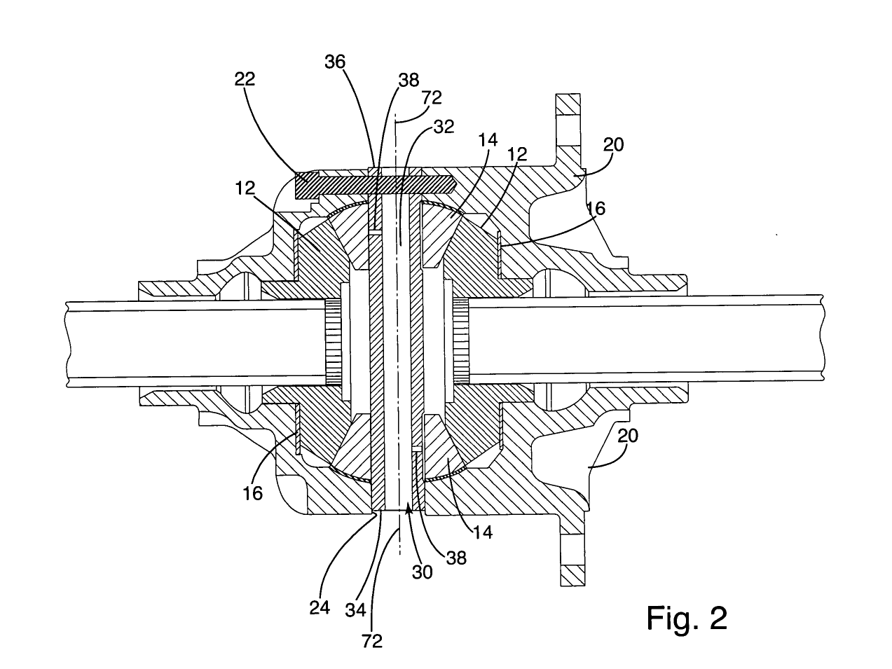

A differential assembly 10 constructed in accordance with the illustrated embodiment is shown in FIG. 1. An outer housing 8 surrounds a differential case 20 at least partially submerged in a lubrication fluid 52. The differential case 20 receives a torque input from a drive shaft (not shown) and transfers the torque to output shafts 6. More specifically, a differential case 20 within the outer housing 8 is rotated about a differential axis 70 by the drive shaft. The torque is transferred from the differential case 20 to the output shafts 6 by a pair of pinion gears 14 and side gears 12 located within the differential case 20. As illustrated in FIG. 2, the side gears 12 are coupled to the output shafts 6. The differential assembly 10 also includes a pinion shaft 30 which secures the pinion gears 14 for rotation with the differential case 20, as the differential case 20 is rotated about the differential axis 70. The pinion gears are coupled to the side gears so that the side gears 12 rotate with the differential case. The pinion gears 14 are configured to be rotatable around the pinion shaft 30 so that the side gears 12 may rotate relative to one another, such as when the vehicle is turning. As described in greater detail below, the pinion shaft 30 includes lubrication pathways to draw lubrication fluid 52 between the pinion gears 14 and pinion shaft 30 to reduce friction as the pinion gears rotate about the pinion shaft.

The differential case 20 supports the side gears 12 and pinion gears 14. The side gears 12 and pinion gears 14 are similar to those found in most differentials and may vary in size and shape depending upon the desired application. Pinion gears 14 generally include a bore 15 in which the pinion shaft 30 is disposed so that the pinion gears 14 rotate about a pinion shaft axis 72. The differential 10 is illustrated as having two pinion gears 14, although the configuration may vary so that more pinion gears may be used.

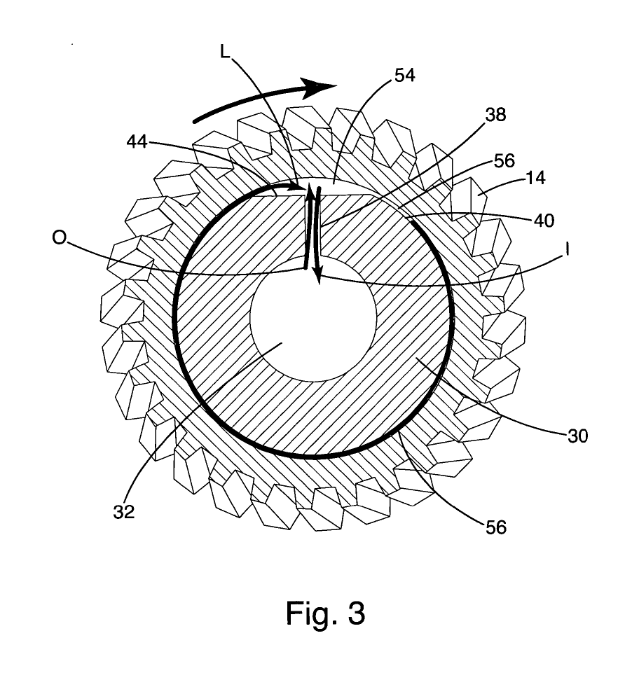

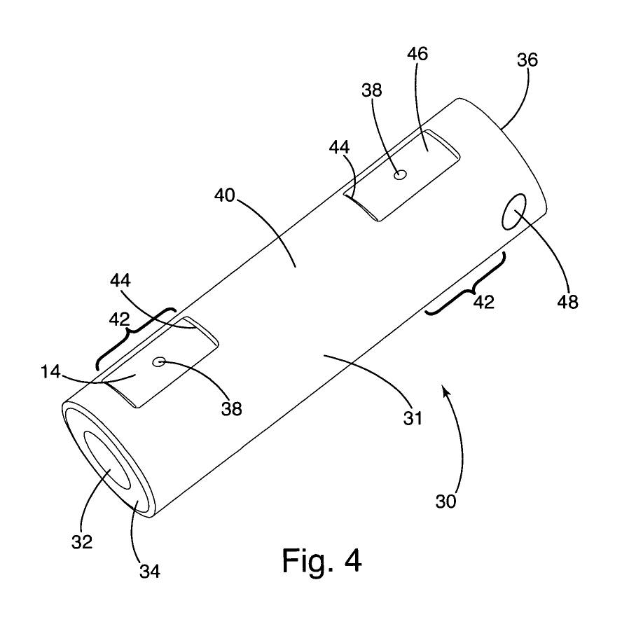

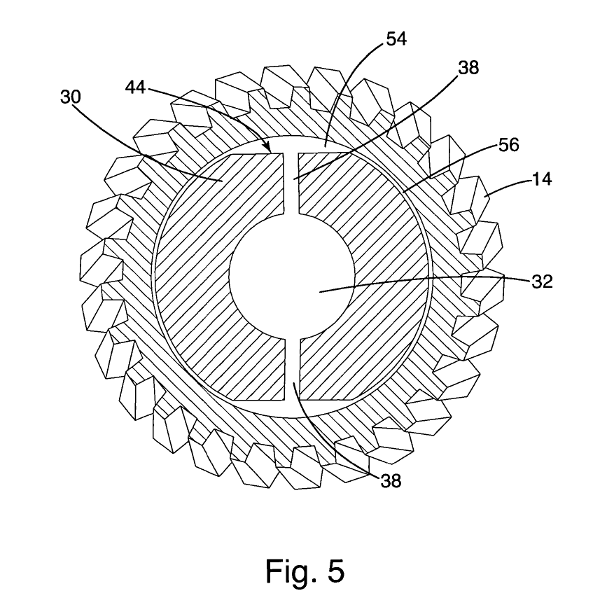

As illustrated in FIGS. 4 and 5, the pinion shaft 30 includes a generally tubular body that is preferably concentric about a shaft axis 72. The body includes a first end 34, a second end 36, an outer surface 40, and a shaft axis 72. The pinion shaft 30 also defines an elongated cavity 32 extending along the shaft axis 72 and at least one lubrication passage 38 (FIG. 4). As illustrated, both of the ends 34, 36 are open communicating with the cavity 32, of course only one of the ends 34, 36 may be open communicating with the cavity, with the other end 34, 36 being closed. The elongated cavity 32 receives lubrication fluid 52 during rotation of the pinion shaft. The received lubrication fluid by the elongated cavity 32 then passes to the lubrication passage 38. The lubrication fluid 52 passes out of the passage 38 to form a lubrication barrier 58 between the gear shaft 30 and the pinion gears 14 (FIG. 3).

The elongated cavity 32 may be formed in virtually any size and shape sufficient for the application so long as the stiffness of the gear shaft 30 meets any specified requirements for moment of inertia in axial, bending, and torsional directions. The elongated cavity 32 may have a cross-section that is oval, hexagonal, square, round, or any other desired shape. The elongated cavity 32 may extend completely from the first end 34 to the second end 36 as shown in the drawings or be divided into separate cavities extending toward the center of the pin from each end 34, 36. In the illustrated embodiment, the elongated cavity 32 includes an inside diameter that is 10% to 20% of the outside diameter of the gear shaft 30, but this may vary with the application and any specified requirements. The center 31 of the gear shaft 30 experiences minimal loading when used in a differential assembly 10, as compared to areas closer to the ends 34, 36. Therefore, an elongated cavity 32 extending completely between the ends 34, 36 reduces the weight of the pinion shaft while generally meeting loading requirements.

In the illustrated embodiment, the lubrication passage 38 is a round hole drilled in the gear shaft 30 and has a width of approximately 2 mm. The shape and size of the lubrication passage may be configured to balance the flow of fluid between the elongated cavity 32 and the outer surface 40 with the strength of the pinion shaft 30.

As illustrated in FIGS. 3 and 4, the outer surface 40 of the pinion shaft 30 is generally cylindrical. The outer surface 40 generally includes a gear engagement area 42 upon which the gears or pinions 14 rotate about the shaft axis 72. Recessed pockets 44 are included in the gear engagement area 42 as illustrated in FIGS. 3 and 4 to allow increased lubrication between the pinion shaft 30 and pinion gears 14. The recessed pockets 44 may be made in any size and shape and, in the illustrated embodiment, include a planar surface 46.

During operation, the differential case 20 is rotated about the differential axis 70 so that each end 34, 36 of the pinion shaft 30 will alternately enter the lubrication fluid 52 within the outer housing 8, as illustrated in FIG. 1. Of course, one skilled in the art may readily recognize that the lubrication fluid 52 within the outer housing 8 may submerge both ends 34, 36 of the pinion shaft. When a particular end of the gear shaft is disposed in the lubrication fluid 52, a portion of the lubrication fluid may be received within the elongated cavity 32 and directed to the lubrication passage 38. The lubrication fluid 52 is transmitted through the elongated cavity 32 and the lubrication passage 38 to lubricate the interface between the pinion gears 14 and gear shaft 30 thereby reducing frictional forces between the pinion gears and pinion shaft. Therefore, as the pinion gears 14 rotate, lubrication fluid is drawn out of or forced into the lubrication passage 38 so that lubrication fluid flows around the gear shaft 30 to create a lubrication barrier 58 between the pinion shaft 30 and the pinion gears 14 (FIG. 3). As shown in FIGS. 3 and 4, if the pinion shaft 30 includes a recessed pockets 44, the recessed pockets may allow lubrication fluid to form a lubricating bath 54 between the recessed pockets 44 and the pinion gear 14.

The pinion shaft 30 may also include a locking passage 48 wherein a locking pin 22 as illustrated in FIGS. 1 and 4, couples the pinion shaft 30 to the differential case 20. Of course, the locking passage 48 may not extend completely through the shaft but instead may be a recess or depression to secure the pinion shaft 30 to the differential case 20.

The elongated cavity 32 reduces the weight of the pinion shaft while also facilitating the lubrication between the pinion shaft 30 and pinion gears 14. The lubrication passage 38 passing between the outer surface 40 of the pinion shaft 30 and the elongated cavity 32 allows lubrication fluid 52 to flow from within the elongated cavity to the gear engagement area 42. The flow of lubrication fluid reduces friction between the pinion gear 14 and pinion shaft 30, thereby improving longevity of the differential assembly 10. It should be readily recognized that, in some embodiments, the flow of lubrication fluid 52 may be reversed so that the lubrication fluid enters near the recessed pockets 44 to form the lubrication barrier 58, flows through the lubrication passage 38, and out the elongated cavity 32. The flow of lubrication fluid around the pinion shaft 30 between the pinion shaft and pinion gear 14 is illustrated in FIG. 3 by arrow “L”, the flow of lubrication fluid through lubrication passage 38 into the elongated cavity is illustrated by arrow “I”, and the flow of lubrication fluid outwardly from within the elongated cavity is illustrated by arrow “O”.

The elongated cavity 32 and lubrication passage 38 allow lubrication fluid 52 to pass between the pinion gear 14 and pinion shaft 30 to create a lubrication barrier 58 between the pinion shaft and pinion gear to reduce friction and increase longevity. The lubrication fluid 52 may enter the elongated cavity 32 when an end 34, 36 is submerged and pass out the lubrication passage 38 to form a lubrication barrier 58 between the pinion gear 14 and pinion shaft 32. Alternatively, as the pinion gear 14 and one end 34, 36 of the pinion shaft 30 are submerged in the lubrication fluid 52, the lubrication fluid may be drawn between the pinion gear and pinion shaft to pass through the lubrication passage 38 and into the elongated cavity 32.

Another embodiment of the pinion shaft 30 may be seen in FIG. 5 wherein the pinion shaft includes two recessed pockets 44 and two passages 38 in the gear engagement area.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A gear shaft comprising a tubular body defining an axially extending cavity, an outer surface having a first gear engagement area for rotatably supporting a gear and a passage extending from said cavity to said gear engagement area.

2. The gear shaft of claim 1 wherein said tubular body further includes a first open end and a second open end communicating with said cavity, said cavity extending between said first end and said second end.

3. The gear shaft of claim 2 wherein said tubular shaft further includes a second gear engagement area and a second passage extending from said cavity to said second gear engagement area.

4. The gear shaft of claim 1 wherein said outer surface further defines a recessed pocket in said first gear engagement area, said passage extending outwardly from said cavity to said recessed pocket.

5. The gear shaft of claim 4 wherein said recessed pocket includes a planar surface.

6. The gear shaft of claim 1 wherein said wherein said tubular body includes a first open end communicating with said cavity.

7. A differential assembly having a differential case rotatable about an axis, and a gear assembly being partially submerged in a lubrication fluid, said gear assembly comprising:
a pinion shaft secured to the differential case for rotation therewith, said pinion shaft including a first open end and a second open end configured to be submerged in the lubrication fluid as the differential case rotates, wherein said pinion shaft further includes an elongated cavity extending between said first and second ends, an outer surface and a passage extending between said elongated cavity and said outer surface, and wherein said elongated cavity receives the lubrication fluid as said ends are submerged during rotation, said received lubrication fluid passing from said elongated cavity outwardly through said passage.

8. The differential assembly of claim 7 wherein said outer surface includes a gear engagement area, said passage extending outwardly from said cavity to said gear engagement area and said gear assembly including a pinion gear rotatably supported by said gear engagement area of said pinion shaft and wherein the lubrication fluid passing through said passage forms a lubrication barrier between said gear engagement area and said pinion gears.

9. The differential assembly of claim 7 wherein said gear engagement area further includes a recessed pocket, said recessed pocket and said pinion gears defining a lubrication bath therebetween.

10. The differential assembly of claim 9 wherein as said pinion gears rotate about said pinion shaft, said pinion gears draw the lubrication fluid from said lubrication bath to create a lubrication barrier between said pinion shaft and said pinion gears.

11. A differential assembly comprising:
a differential case;
a pinion shaft secured to said differential case for rotation therewith;
a set of spaced apart pinion gears rotatably supported by said pinion shaft; and
wherein said pinion shaft defines an elongated cavity, an outer surface, and a passage extending from said elongated cavity to said outer surface.

12. The differential assembly of claim 11 wherein said outer surface includes a gear engagement area, said passage extending outwardly from said elongated cavity to said gear engagement area.

13. The differential assembly of claim 12 wherein said gear engagement area further includes a recessed pocket, said passage extending from said elongated cavity to said recessed pocket.
